(19) United States
(12) Patent Application Publication
(10) Pub. No.: US 2021/0143386 A1
(43) Pub. Date: May 13, 2021

(54) ZINC SECONDARY BATTERY

(71) Applicant: Toyota Jidosha Kabushiki Kaisha, Toyota-shi Aichi-ken (JP)

(72) Inventors: Takamasa Yabuzaki, Toyota-shi Aichi-ken (JP); Yukihisa Katayama, Nagoya-shi Aichi-ken (JP)

(21) Appl. No.: 17/092,658

(22) Filed: Nov. 9, 2020

(30) Foreign Application Priority Data
Nov. 11, 2019 (JP) 2019-204134

(51) Int. Cl. H01M 2/16; H01M 4/24; H01M 4/66

(52) U.S. Cl. CPC H01M 2/1686; H01M 4/668; H01M 4/244; H01M 2/1673

(57) ABSTRACT

A zinc secondary battery includes a positive electrode, a separator, an electrolyte solution, and a negative electrode. The electrolyte solution includes water. The separator is interposed between the positive electrode and the negative electrode. The negative electrode includes a first layer, a second layer, and a negative electrode current collector. The first layer is interposed between the second layer and the negative electrode current collector. The second layer includes a portion that is interposed between the positive electrode and the first layer. The first layer includes at least one selected from the group consisting of zinc oxide and zinc. The second layer includes a dielectric material and a conductive material. The dielectric material covers the conductive material. The conductive material is electrically connected to the negative electrode current collector. The conductive material is not electrically connected to the first layer.

### CROSS REFERENCE TO RELATED APPLICATIONS

This nonprovisional application claims priority to Japanese Patent Application No. 2019-204134 filed on Nov. 11, 2019, with the Japan Patent Office, the entire contents of which are hereby incorporated by reference.

### BACKGROUND

### Field

The present disclosure relates to a zinc secondary battery.

### Description of the Background Art

Japanese Patent Laying-Open No. 2019-102352 discloses a zinc secondary battery.

### SUMMARY

Research has been underway for zinc secondary batteries. Zinc secondary batteries are one type of alkaline secondary batteries. Zinc secondary batteries are expected to have high energy density.

In a negative electrode of a zinc secondary battery, dissolution-deposition reaction of zinc may take place during charge and discharge. The zinc deposited during charge may form dendrites. The dendrites may grow during repeated charge and discharge. The dendrites may extend from the negative electrode toward the positive electrode. When the dendrites reach the positive electrode, an internal short circuit occurs; in other words, the zinc secondary battery reaches its end of life.

An object of the present disclosure is to improve life of a zinc secondary battery. In the following, the technical structure and the effects according to the present disclosure are described. It should be noted that the action mechanism according to the present disclosure includes presumption. The scope of claims is not limited by whether or not the action mechanism according to the present disclosure is correct.

(1) A zinc secondary battery according to the present disclosure includes a positive electrode, a separator, an electrolyte solution, and a negative electrode. The electrolyte solution includes water. The separator is interposed between the positive electrode and the negative electrode. The negative electrode includes a first layer, a second layer, and a negative electrode current collector. The first layer is interposed between the second layer and the negative electrode current collector. The second layer includes a portion that is interposed between the positive electrode and the first layer. The first layer includes at least one selected from the group consisting of zinc oxide and zinc. The second layer includes a dielectric material and a conductive material. The dielectric material covers the conductive material. The conductive material is electrically connected to the negative electrode current collector. The conductive material is not electrically connected to the first layer.

It is considered that zinc deposition reaction tends to occur during a transient phenomenon in high-current charging. For example, immediately after the start of a high current charging, the electric potential across the plane of the negative electrode is not uniform and thereby local current convergence tends to occur. It is considered that zinc dendrites tend to be formed at places of current convergence.

In the zinc secondary battery according to the present disclosure, the negative electrode includes a first layer and a second layer. The first layer includes a negative electrode active material (zinc oxide, zinc). The second layer includes a dielectric material and a conductive material. Thus, a hybrid system consisting of a battery and a capacitor is formed.

FIG. 1 is a schematic circuit diagram illustrating the action mechanism according to the present disclosure.

A first layer 21 and a positive electrode 10 together form a battery. A second layer 22 and positive electrode 10 together form a capacitor. The battery and the capacitor together form a parallel circuit.

During high-current charging, part of the current may be distributed to the capacitor (second layer 22). A capacitor tends to receive current at a faster rate than a battery. When the capacitor receives part of the current, the load on the battery (first layer 21) may be reduced. This may reduce the nonuniformity of electric potential across the plane of the negative electrode (first layer 21). As a result, dendrite formation may be reduced. The reduced dendrite formation may improve life of the zinc secondary battery.

(2) The conductive material may include a porous metal material.

The porous metal material may have a large specific surface area. When the conductive material includes a porous metal material, the capacitor may have an increased capacitance. In other words, the capacitor may be capable of receiving higher current. As a result, dendrite formation may be reduced.

(3) The second layer may further include a hydrophilic resin material.

The second layer according to the present disclosure includes a portion that is interposed between the positive electrode and the first layer. Therefore, the second layer according to the present disclosure may further have the function to reduce dendrite growth, in addition to the above-described function as a capacitor.

When dendrites are formed in the first layer, the dendrites may extend toward the positive electrode and reach the second layer. The electrolyte solution includes water. The hydrophilic resin material included in the second layer may become swollen with the electrolyte solution. The swollen hydrophilic resin material may function as a barrier against the extending dendrites. In other words, the second layer may reduce dendrite growth.

(4) The second layer may further include an ion trapping material.

It is considered that zinc dissolution reaction produces zincate ions [Zn(OH)₄²⁻]. It is considered that, during charge, reduction reaction of the zincate ions may cause zinc dendrite formation. The ion trapping material may trap the zincate ions. Thus, dendrite growth may be reduced.

(5) The second layer may further include a magnetic material.

When dendrites extend and reach the second layer, zincate ions around the dendrites may receive the Lorentz force due to the magnetic material included in the second layer. This may reduce localized zinc deposition, namely, dendrite growth.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic circuit diagram illustrating the action mechanism according to the present disclosure.

FIG. 2 is a conceptual view illustrating the configuration of a zinc secondary battery according to the present embodiment.

FIG. 3 is a conceptual view illustrating the configuration of a second layer according to the present embodiment.

### DETAILED DESCRIPTION

In the following, embodiments of the present disclosure (hereinafter also called “present embodiment”) are described. However, the description below does not limit the scope of claims.

In the present embodiment, phrases such as “from 0.1 parts by mass to 10 parts by mass” mean a range that includes the boundary values, unless otherwise specified. For example, the phrase “from 0.1 parts by mass to 10 parts by mass” means a range of “not less than 0.1 parts by mass and not more than 10 parts by mass”.

<Zinc Secondary Battery>

FIG. 2 is a conceptual view illustrating the configuration of a zinc secondary battery according to the present embodiment.

A zinc secondary battery 100 includes a positive electrode 10, a separator 30, an electrolyte solution 40, and a negative electrode 20. Positive electrode 10, separator 30, and negative electrode 20 are immersed in electrolyte solution 40. Positive electrode 10, separator 30, electrolyte solution 40, and negative electrode 20 may be accommodated in a predetermined case 50. Case 50 may have any configuration. Case 50 may be a pouch made of an aluminum-laminated film, for example. Case 50 may be a metal container, for example. Case 50 may be a resin container, for example.

Separator 30 is interposed between positive electrode 10 and negative electrode 20. For example, a stacked unit consisting of positive electrode 10, separator 30, and negative electrode 20 may be wound in a spiral fashion. For example, a plurality of stacked units each consisting of positive electrode 10, separator 30, and negative electrode 20 may be stacked on top of one another. In this configuration, separator 30 is also interposed between adjacent stacked units.

<<Negative Electrode>>>

Negative electrode 20 according to the present embodiment may form a hybrid system consisting of a battery and a capacitor. Negative electrode 20 may be in sheet form, for example. Negative electrode 20 includes a first layer 21, a second layer 22, and a negative electrode current collector 23.

(Negative Electrode Current Collector)

Negative electrode current collector 23 is electrically conductive. Negative electrode current collector 23 is electrically connected to a negative electrode terminal (not illustrated). Negative electrode current collector 23 may include a metal foil, a perforated metal, and/or a porous metal sheet, for example. Negative electrode current collector 23 may have a thickness from 10 μm to 10 mm, for example. Negative electrode current collector 23 may include copper (Cu), nickel (Ni), and/or Cu—Ni alloy, for example.

(First Layer)

First layer 21 is electrically connected to negative electrode current collector 23. First layer 21 is interposed between second layer 22 and negative electrode current collector 23. First layer 21 may be formed on a surface of negative electrode current collector 23. First layer 21 may be formed on both sides of negative electrode current collector 23. First layer 21 may have a thickness from 10 μm to 10 mm, for example.

In a way, first layer 21 is a negative electrode active material layer. First layer 21 includes a negative electrode active material. The negative electrode active material is zinc oxide (ZnO) and zinc (Zn). In other words, first layer 21 includes at least one selected from the group consisting of zinc oxide and zinc. The charge-discharge reaction at the negative electrode is expressed by the following formula (1).

Zn+2OH⁻→ZnO+H₂O+2e⁻ (1)

In the above formula (1), the reaction proceeding from the left side to the right side is discharging reaction, and the reaction proceeding from the right side to the left side is charging reaction.

In first layer 21, dissolution-deposition reaction of zinc may also take place. The dissolution-deposition reaction of zinc is expressed by the following formula (2).

Zn+40H⁻→[Zn(OH)₄]²⁻+2e⁻ (2)

In the above formula (2), the reaction proceeding from the left side to the right side is dissolution reaction. The dissolution reaction may take place along with discharging reaction. The reaction proceeding from the right side to the left side is deposition reaction. The deposition reaction may take place along with charging reaction.

According to the present embodiment, it is considered that second layer 22 described below forms a capacitor. The capacitor may reduce convergence of current in first layer 21. As a result of this reduction in convergence of current, localized zinc deposition, namely dendrite formation may be reduced.

First layer 21 may consist essentially of the negative electrode active material. First layer 21 may further include a binder and the like in addition to the negative electrode active material. The amount of the binder may be, for example, from 0.1 parts by mass to 10 parts by mass relative to 100 parts by mass of the negative electrode active material. The binder may include any component. The binder may include at least one selected from the group consisting of carboxymethylcellulose (CMC), styrene-butadiene rubber (SBR), and polytetrafluoroethylene (PTFE), for example.

First layer 21 may further include a metal other than zinc. The metal other than zinc may have a higher redox potential than that of zinc. For example, when a metal nobler than zinc coexists, dissolution-deposition reaction of zinc may be inhibited. First layer 21 may include at least one selected from the group consisting of indium (In), thallium (TI), lead (Pb), and bismuth (Bi), for example. The metal other than zinc may be in oxide form. First layer 21 may include at least one selected from the group consisting of indium oxide, thallium oxide, lead oxide, and bismuth oxide, for example. The amount of the metal may be, for example, from 0.1 parts by mass to 10 parts by mass relative to 100 parts by mass of the negative electrode active material.

(Second Layer)

It is considered that second layer 22 and positive electrode 10 together form a capacitor. It is considered that second layer 22 has substantially no contribution to electrochemical reaction. Second layer 22 may be formed on only one side of negative electrode current collector 23. Second layer 22 may be formed on both sides of negative electrode current collector 23.

Second layer 22 includes a portion that is interposed between positive electrode 10 and first layer 21. Part of second layer 22 may be interposed between positive electrode 10 and first layer 21. The entire second layer 22 may be interposed between positive electrode 10 and first layer 21. When at least part of second layer 22 is interposed between positive electrode 10 and first layer 21, dendrite growth may be reduced. For example, second layer 22 may be larger than first layer 21. For example, second layer 22 may cover first layer 21. For example, second layer 22 may shield first layer 21 from positive electrode 10.

Second layer 22 includes a conductive material 2 (described below). Conductive material 2 is electrically connected to negative electrode current collector 23 at a connection part 24. For example, conductive material 2 may be welded to negative electrode current collector 23 at connection part 24. Connection part 24 may be electrochemically active. When connection part 24 comes into contact with electrolyte solution 40, a phenomenon such as metal deposition and/or gas generation may occur. For example, connection part 24 may be positioned where it does not come into contact with electrolyte solution 40. For example, connection part 24 may have a corrosion inhibitor and/or the like applied thereto. For example, connection part 24 may be covered with an alkaline-resistant material, a water-repellent material, and/or the like.

FIG. 3 is a conceptual view illustrating the configuration of a second layer according to the present embodiment.

Second layer 22 includes a dielectric material 1 and conductive material 2. Dielectric material 1 covers conductive material 2. With dielectric material 1 covering conductive material 2, dielectric material 1 and conductive material 2 together may form a capacitor.

(Conductive Material)

Conductive material 2 is electrically conductive. Conductive material 2 is electrically connected to negative electrode current collector 23. Conductive material 2 is not electrically connected to first layer 21. Therefore, second layer 22 and first layer 21 together form a parallel circuit. As long as conductive material 2 is not electrically connected to first layer 21, second layer 22 may be in contact with first layer 21.

Conductive material 2 may include Cu, Ni, Cu—Ni alloy, and/or conductive carbon material, for example. As the conductive carbon material, carbon monolith and/or carbon fiber aggregate may be considered, for example. Conductive material 2 may have any shape. The conductive material may be in sheet form, for example. Conductive material 2 may have a thickness from 10 μm to 10 mm, for example. Conductive material 2 may be flexible. When conductive material 2 is flexible, conductive material 2 may be easily formed and/or machined, for example.

For example, conductive material 2 may have a shape with a large specific surface area. When conductive material 2 has a large specific surface area, the capacitor may have an increased capacitance. Conductive material 2 may include a porous metal material, for example. The porous metal material may have a large specific surface area. Conductive material 2 may include at least one selected from the group consisting of porous metal sheet, foam metal, perforated metal, and expanded metal, for example.

For example, conductive material 2 may have microscopic irregularities on its surface. The microscopic irregularities may increase the specific surface area of conductive material 2. The microscopic irregularities may be formed by chemical etching, for example.

(Dielectric Material)

Dielectric material 1 is interposed between electrolyte solution 40 and conductive material 2. When electrolyte solution 40 comes into contact with conductive material 2, a phenomenon such as metal deposition and/or gas generation may occur.

Dielectric material 1 is a material in which its dielectricity is superior to its conductivity. When dielectric material 1 is polarized, electric charges are stored. Dielectric material 1 may have a relative permittivity from 2 to 10000, for example. Dielectric material 1 may be electrically insulating. Dielectric material 1 may be semiconductive.

In the present embodiment, dielectric material 1 is in contact with electrolyte solution 40 (aqueous alkali solution). Dielectric material 1 may be alkaline resistant. Dielectric material 1 may be acid resistant. Dielectric material 1 may be heat resistant.

Dielectric material 1 may include a resin material, for example. Dielectric material 1 may include at least one selected from the group consisting of polypropylene (PP), polyethylene (PE), polystyrene (PS), polyamide (PA), PTFE, ABS resin, and acrylic resin, for example.

Dielectric material 1 may be highly adhesive to conductive material 1. For example, PP may be highly adhesive to metal.

Dielectric material 1 may include a metal oxide, for example. Dielectric material 1 may include at least one selected from the group consisting of titanium oxide, aluminum oxide, iron oxide, and silicon oxide, for example.

Dielectric material 1 may include a ferroelectric. When dielectric material 1 includes a ferroelectric, the capacitor may have an increased capacitance. For example, dielectric material 1 may include an oxide ferroelectric. For example, dielectric material 1 may include at least one selected from the group consisting of barium titanate, lead zirconate titanate (PZT), and strontium titanate. For example, dielectric material 1 may include both a resin material (dielectric) and an oxide ferroelectric. For example, the resin material (dielectric) may retain the oxide ferroelectric. For example, the resin material and the oxide ferroelectric may form a so-called sea-island structure.

The method of covering is not limited. For example, dielectric material 1 may include particles (powder). For example, a polymer binder and/or the like may be used to secure dielectric material 1 to a surface of conductive material 2. For example, a dip coating technique may be used to cover conductive material 2. More specifically, conductive material 2 may be immersed in a dispersion of dielectric material 1 (particles). Dielectric material 1 is adhered to a surface of conductive material 2, and thus dielectric material 1 may cover conductive material 2. Examples of the dispersion of PP particles include “Arrowbase (registered trademark)” manufactured by Unitika Ltd., “HARDLEN (registered trademark)” manufactured by Toyobo Co., Ltd., “SURFLEN (registered trademark)” manufactured by Mitsubishi Chemical Corporation, and the like.

The average covering thickness of dielectric material 1 may be from 1 μm to 100 μm, for example. The average covering thickness of dielectric material 1 may be from 1 μm to 30 μm, for example. When the average covering thickness is 30 μm or less, the operation of the capacitor may be stable, for example. The average covering thickness refers to the arithmetic mean of covering thicknesses at five or more positions.

(Hydrophilic Resin Material)

Second layer 22 may further include a hydrophilic resin material 3, for example. When conductive material 2 is a porous metal material, for example, internal pores of the porous metal material may be filled with hydrophilic resin material 3. Hydrophilic resin material 3 may be swollen with electrolyte solution 40. The swollen hydrophilic resin material 3 may reduce dendrite growth. Further, when hydrophilic resin material 3 retains electrolyte solution 40, the operation of the capacitor may be stable. Hydrophilic resin material 3 may be partially or entirely in gel form.

Hydrophilic resin material 3 may have a phase-separated structure, for example. The phase-separated structure may reduce dendrite growth. Hydrophilic resin material 3 may include at least one selected from the group consisting of polyethylene glycol (PEG), hydroxypropylcellulose (HPC), polyvinyl alcohol (PVA), ethylene-(vinyl acetate) copolymer (EVA), and polyacrylic acid (PAA), for example.

Hydrophilic resin material 3 may include an ion-exchange resin material, for example. Hydrophilic resin material 3 may include a sulfo group, for example. When hydrophilic resin material 3 exhibits ion-exchanging action, zincate ions may be trapped by hydrophilic resin material 3, for example. As a result, dendrite growth may be reduced. Hydrophilic resin material 3 may include at least one selected from the group consisting of Nafion (registered trademark), polystyrene sulfonic acid, and polyvinylsulfonic acid, for example.

(Ion Trapping Material)

Second layer 22 may further include an ion trapping material 4. Ion trapping material 4 may trap zincate ions. When ion trapping material 4 traps zincate ions, dendrite growth may be reduced. Ion trapping material 4 may be in powder form, for example. Ion trapping material 4 may be secured within second layer 22 by means of a polymer binder, for example. Ion trapping material 4 may be retained by hydrophilic resin material 3.

Ion trapping material 4 may be alkaline resistant, for example. When ion trapping material 4 is alkaline resistant, dendrite growth may be reduced for an extended period of time. Ion trapping material 4 may have a large specific surface area, for example. When ion trapping material 4 has a large specific surface area, zincate ions may be easily trapped.

Ion trapping material 4 may include an organic compound, for example. Ion trapping material 4 may consist essentially of an organic compound. For example, as described above, an ion-exchange resin material (hydrophilic resin material 3) may also function as ion trapping material 4.

Ion trapping material 4 may include an inorganic compound, for example. Ion trapping material 4 may consist essentially of an inorganic compound. Ion trapping material 4 may include at least one selected from the group consisting of aluminosilicate, barium titanate, barium sulfate, and bismuth oxide, for example. Ion trapping material 4 may include hydrotalcite, zeolite, clay mineral (such as halloysite), for example.

(Magnetic Material)

Second layer 22 may further include a magnetic material 5, for example. When dendrites extend and reach second layer 22, zincate ions around the dendrites may receive the Lorentz force due to magnetic material 5 included in second layer 22. This may reduce localized zinc deposition, namely, dendrite growth. Magnetic material 5 may be in powder form, for example. Magnetic material 5 may be secured within second layer 22 by means of a polymer binder, for example. Magnetic material 5 may be retained by hydrophilic resin material 3.

Magnetic material 5 may include at least one selected from the group consisting of ferrite magnetic powder and neodymium magnetic powder, for example. For example, it is considered that the magnetic powder used in printer toner is suitable as magnetic material 5 according to the present embodiment.

Magnetic material 5 may be alkaline resistant. When magnetic material 5 is not sufficiently alkaline resistant, magnetic material 5 may be covered with an alkaline-resistant material and/or the like. For example, ferrite particles may be covered with acrylic resin and/or the like.

<<Positive Electrode>>>

Positive electrode 10 may be in sheet form, for example. Positive electrode 10 includes a positive electrode active material layer 11 and a positive electrode current collector 13. Positive electrode current collector 13 may include any material. Positive electrode current collector 13 may include a porous metal sheet, for example. Positive electrode current collector 13 may have a thickness from 10 μm to 10 mm, for example.

Positive electrode active material layer 11 may be formed on a surface of positive electrode current collector 13. Positive electrode active material layer 11 may be formed on both sides of positive electrode current collector 13. Positive electrode active material layer 11 may have a thickness from 10 μm to 10 mm, for example.

Positive electrode active material layer 11 includes a positive electrode active material. The positive electrode active material may include any component. The positive electrode active material may include at least one selected from the group consisting of nickel hydroxide, nickel oxyhydroxide, manganese hydroxide, manganese oxyhydroxide, manganese dioxide, silver, silver oxide, and oxygen gas, for example.

Positive electrode active material layer 11 may consist essentially of the positive electrode active material. In addition to the positive electrode active material, positive electrode active material layer 11 may further include a conductive aid and a binder, for example. The conductive aid may include cobalt (Co), cobalt oxide, and/or cobalt hydroxide, for example. The binder may include CMC and/or PTFE, for example.

<<Separator>>

Separator 30 is interposed between positive electrode 10 and negative electrode 20. Separator 30 permits permeation of electrolyte solution 40 therethrough. Separator 30 is electrically insulating. Separator 30 may have a thickness from 10 μm to 100 μm, for example.

Separator 30 may include a porous film made of polyolefin, for example. The polyolefin may include at least one selected from the group consisting of PE and PP, for example. Separator 30 may include a nonwoven fabric made of a chemical fiber, for example. The chemical fiber may include at least one selected from the group consisting of PP fiber, cellulose fiber, PVA fiber, EVA fiber, and PA fiber, for example. Separator 30 may have subjected to hydrophilization treatment, for example. The hydrophilization treatment may include a treatment for introducing sulfo groups, for example.

<<Electrolyte Solution>>>

Electrolyte solution 40 includes an aqueous alkali solution. Electrolyte solution 40 may consist essentially of an aqueous alkali solution. The aqueous alkali solution includes an alkali metal hydroxide and water. Electrolyte solution 40 may include at least one selected from the group consisting of potassium hydroxide (KOH), lithium hydroxide (LiOH), and sodium hydroxide (NaOH), for example. The concentration of the hydroxide may be from 0.1 mol/L to 20 mol/L, for example. Electrolyte solution 40 may further include various additives and the like.

### EXAMPLES

Next, examples according to the present disclosure (herein also called “the present example”) are described. However, the description below does not limit the scope of claims.

<Producing Battery>

In the below manner, a zinc secondary battery was produced.

### Example 1

(Forming Second Layer)

“Celmet (registered trademark)” manufactured by Sumitomo Electric Industries, Ltd. was prepared. This material was a porous metal sheet. This material was made of Ni. This material was plated with Cu. Thus, conductive material 2 was prepared. In other words, conductive material 2 according to the present example included a porous metal material.

As a dispersion of dielectric material 1, “Arrowbase (registered trademark)” manufactured by Unitika Ltd. was prepared. This dispersion contained PP particles dispersed therein. This dispersion was diluted with methanol. After dilution, conductive material 2 was immersed in the dispersion. The upper 10-mm part of conductive material 2 was not immersed in the dispersion. Conductive material 2 was taken out of the dispersion. Thus, conductive material 2 (porous metal material) was covered with dielectric material 1 (PP). The average covering thickness was about 3 μm. In this way, second layer 22 was formed.

The uniformity of the covering was evaluated by the below manner.

An aqueous KOH solution (concentration, 6 mol/L) was prepared. Second layer 22 was immersed in the aqueous KOH solution. Further, a Ni metal plate as a counter electrode was also immersed in the aqueous KOH solution. Voltage was applied between second layer 22 and the metal plate. The voltage was gradually increased from 0 V. In the present example, it was observed that substantially no electrochemical reaction took place at a voltage of 2.0 V or lower. It is considered that any nonuniformity in the covering, if present, causes electrochemical reaction (such as gas generation) at a low voltage.

As hydrophilic resin material 3, PVA was prepared. An aqueous KOH solution (concentration, 3 mol/L) was prepared. To 100 ml of the aqueous KOH solution, 20 g of PVA was added, and thereby a mixed liquid was prepared. The resulting mixed liquid was heated while stirring. The highest temperature of the mixed liquid during heating was 90° C. By the stirring and heating, substantially the entire amount of PVA was dissolved. After PVA was thus dissolved, second layer 22 was immersed in the mixed liquid. After immersion, vacuuming and defoaming were sequentially carried out. Subsequently, second layer 22 was left to stand in the mixed liquid. After this, second layer 22 was taken out. It was observed that PVA was swollen with the aqueous KOH solution and gelled. Excess gel (PVA) was scraped off. In this way, hydrophilic resin material 3 and electrolyte solution 40 were retained within second layer 22.

(Forming First Layer)

A planetary centrifugal mixer was prepared. To the stirring vessel of the mixer, zinc oxide (negative electrode active material), CMC, SBR, and water were added in a predetermined ratio, and thus a mixture was prepared. The resulting mixture was stirred in the mixer. The stirring continued for 20 min. Thus, a slurry was prepared. The slurry was white.

As negative electrode current collector 23, a perforated Cu metal was prepared. The perforated metal had an aperture ratio of 40%. The slurry was applied to the perforated metal and dried to form first layer 21. The slurry was not applied to the upper 10-mm part of negative electrode current collector 23. The amount of the slurry thus applied was adjusted so as to ensure a capacity density of first layer 21 of 50 mAh/cm². The temperature for drying the slurry was 60° C. The duration of drying was one hour. First layer 21 and negative electrode current collector 23 were rolled by means of a roll press. The linear pressure applied by the roll press was 0.3 tons.

(Producing Negative Electrode)

A protruded portion of negative electrode current collector 23 (a portion without first layer 21 formed thereon) and a protruded portion of conductive material 2 (a portion without dielectric material 1 adhered thereto) were electrically connected to each other with resistance welding. Thus, connection part 24 was formed.

In this way, negative electrode 20 was produced. Negative electrode 20 included first layer 21, second layer 22, and negative electrode current collector 23. To negative electrode 20, a negative electrode terminal was connected.

(Assembly)

Positive electrode 10 was prepared. Positive electrode 10 included positive electrode active material layer 11 and positive electrode current collector 13. Positive electrode active material layer 11 included nickel hydroxide (positive electrode active material). Positive electrode current collector 13 was “Celmet (registered trademark)” manufactured by Sumitomo Electric Industries, Ltd. This material was made of Ni. To positive electrode 10, a positive electrode terminal was connected.

As separator 30, a nonwoven fabric was prepared. The nonwoven fabric was made of a combination of PVA fibers and cellulose fibers. Negative electrode 20 was wrapped with separator 30. The edge of separator 30 was heat-sealed.

Positive electrode 10 was positioned so that positive electrode 10 faced negative electrode 20 with separator 30 interposed therebetween. Positive electrode 10 was secured to separator 30 by means of a pressure-sensitive adhesive PP tape. Thus, an electrode group was formed.

Each of the positive electrode terminal and the negative electrode terminal was secured to a spacer with screws. The electrode group was placed in case 50. To case 50, electrolyte solution 40 was added dropwise. Electrolyte solution 40 was an aqueous KOH solution (concentration, 6 mol/L). After the dropwise addition of electrolyte solution 40, case 50 was hermetically sealed. After hermetically sealed, it was left to stand.

In this way, zinc secondary battery 100 (nickel-zinc battery) according to the present example was produced. Its design capacity was 300 mAh. The design capacity refers to the stoichiometric capacity calculated from the amount of the active material used.

### Example 2

As ion trapping material 4, halloysite (manufactured by Sigma-Aldrich) was prepared. The halloysite included aluminosilicate. Further, as magnetic material 5, magnetic powder manufactured by Powdertech Co., Ltd. was prepared.

PVA, the halloysite, and the magnetic powder were added to an aqueous KOH solution. Subsequently, in the same manner as in Example 1, a mixed liquid was prepared. The concentration of the halloysite in the mixed liquid was 10 mass %. The concentration of the magnetic powder in the mixed liquid was 10 mass %. Second layer 22 was immersed in the mixed liquid, and thus hydrophilic resin material 3, electrolyte solution 40, ion trapping material 4, and magnetic material 5 were retained within second layer 22. Except these, the same manner as in Example 1 was adopted to produce zinc secondary battery 100.

### COMPARATIVE EXAMPLE

A first layer was formed on a surface of a negative electrode current collector to produce a negative electrode. In other words, a negative electrode according to Comparative Example did not include a second layer. Except this, the same manner as in Example 1 was adopted to produce a zinc secondary battery.

<Cycle Test>

Zinc secondary battery 100 was activated. After activation, a cycle test was carried out according to the charge/discharge pattern specified in Table 1 below. By the cycle test, life of zinc secondary battery 100 was evaluated. Results are shown in Table 2 below. The value under the column “Battery life” in Table 2 below is the cycle number at which SOC (State Of Charge) after charge/discharge decreased to 70% of the SOC at the first cycle. It is considered that the higher the cycle number is, the more improved the life is.

TABLE 1
Cycle test (charge/discharge pattern)

| Item | Procedure |
|---|---|
| CHARGING | CC-CV charging^{1), 2)} |
| | CC charging: CC current = 1 C (300 mA)³⁾, cut-off voltage = 1.95 V |
| | CV charging: CV voltage = 1.90 V, cut-off current = 1/5 C (60 mA) |
| REST | 5 min |
| DISCHARGING | CC discharging |
| | CC current = 1 C (300 mA), cut-off voltage = 1.1 V |
| REST | 5 min |

¹⁾“CC” stands for Constant Current.
²⁾“CV” stands for Constant Voltage.
³⁾“1 C” is a rate at which full charge capacity is discharged in one hour.

TABLE 2
Cycle test (results)

| | Negative electrode | | | | | | |
|---|---|---|---|---|---|---|---|
| | First | | | | | | |
| | layer | | | | | | |
| | Negative | Second layer | | | | | |
| | electrode | | | Hydrophilic | Ion | | |
| | active | Dielectric | Conductive | resin | trapping | Magnetic | Battery |
| | material | material | material | material | material | material | life |
| Ex. 1 | ZnO | PP | Porous | PVA | — | — | 323 |
| | | | metal sheet | | | | |
| Ex. 2 | ZnO | PP | Porous | PVA | Halloysite | Magnetic | 423 |
| | | | metal sheet | | | powder | |

| | | | |
|---|---|---|---|
| Comp. | ZnO | — | 105 |
| Ex. | | | |

<Test Results>

As illustrated in Table 2 above, when second layer 22 was introduced, life tended to be improved. It is considered that second layer 22 formed a capacitor and thereby nonuniformity of electric potential across first layer 21 (negative electrode active material layer) was reduced.

When second layer 22 further included hydrophilic resin material 3, ion trapping material 4, and magnetic material 5, life tended to be improved. It is considered that hydrophilic resin material 3, ion trapping material 4, and magnetic material 5 reduced dendrite growth.

The present embodiments and the present examples are illustrative in any respect. The present embodiments and the present examples are non-restrictive. The technical scope defined by the terms of the claims encompasses any modifications within the meaning equivalent to the terms of the claims. The technical scope defined by the terms of the claims encompasses any modifications within the scope equivalent to the terms of the claims.

What is claimed is:

1. A zinc secondary battery comprising:
a positive electrode;
a separator;
an electrolyte solution; and
a negative electrode,
the electrolyte solution including water,
the separator being interposed between the positive electrode and the negative electrode,
the negative electrode including a first layer, a second layer, and a negative electrode current collector,
the first layer being interposed between the second layer and the negative electrode current collector,
the second layer including a portion that is interposed between the positive electrode and the first layer,
the first layer including at least one selected from the group consisting of zinc oxide and zinc,
the second layer including a dielectric material and a conductive material, the dielectric material covering the conductive material,
the conductive material being electrically connected to the negative electrode current collector,
the conductive material not being electrically connected to the first layer.

2. The zinc secondary battery according to claim 1, wherein the conductive material includes a porous metal material.

3. The zinc secondary battery according to claim 1, wherein the second layer further includes a hydrophilic resin material.

4. The zinc secondary battery according to claim 1, wherein the second layer further includes an ion trapping material.

5. The zinc secondary battery according to claim 1, wherein the second layer further includes a magnetic material.
